(19) United States
(12) Patent Application Publication
(10) Pub. No.: US 2015/0195228 A1
(43) Pub. Date: Jul. 9, 2015

(54) METHOD AND DEVICE FOR TRANSMITTING AN ELECTRONIC CARD

(71) Applicant: TENCENT TECHNOLOGY (SHENZHEN) COMPANY LIMITED, Shenzhen (CN)

(72) Inventors: Luyi Lin, Shenzhen (CN); Xiaomu Wen, Shenzhen (CN)

(21) Appl. No.: 14/662,876

(22) Filed: Mar. 19, 2015

Related U.S. Application Data
(63) Continuation of application No. PCT/CN2013/082343, filed on Aug. 27, 2013.

(30) Foreign Application Priority Data
Sep. 27, 2012 (CN) 201210369791.6

(51) Int. Cl. H04L 12/58; H04L 29/08

(52) U.S. Cl. CPC H04L 51/08; H04L 67/18

(57) ABSTRACT

Embodiments of the present disclosure provide a method and device for transmitting an e-card. The method includes: an e-card sender determines geographical position information of the e-card sender, and uploads an e-card of the e-card sender and the geographical position information of the e-card sender to a card server; receive a list of identifiers of adjacent users determined by the card server according to the geographical position information of the e-card sender; determines an identifier from the list of identifiers of adjacent users, and sending determined identifier to the card server, so that the card server may send the e-card of the e-card sender to an e-card receiver corresponding to the identifier. The technical solutions may support card exchange among multiple persons, thus the card transmission efficiency is increased.

This application is a continuation of International Application No. PCT/CN2013/082343, filed on Aug. 27, 2013. This application claims the benefit and priority of Chinese Patent Application No. 201210369791.6, filed on Sept. 27, 2012, in Chinese Patent Office, entitled “method, system and device for transmitting an electronic card”. The disclosure of which is incorporated herein by reference in its entirety.

### FIELD

The present disclosure relates to information processing technology, and more particularly, to a method and device for transmitting an electronic card (E-card).

### BACKGROUND

In present information age, various information devices emerged, such as, a fixed telephone and a mobile phone for voice transmission; a server and a personal computer (PC) for information resources share and processing; and various televisions for video data display. The devices are generated in specific domains for satisfying some actual requirements. With the advent of the Consumer Electronics, Computer and Communications (3C) fusion technology, people pay more and more attention to the search of comprehensive utilization of information devices of different domains, so as to make the most of the existing device resources to provide better services for people.

At present, content on a paper card (also called business card) can already be electronic and stored in various electronic terminals. On the electronic user card, some personal natural attribute information of the user is generally described. For instance, the natural attribute information may include name, nickname, gender, home address, telephone, self-introduction, marital status, work unit, e-mail address, remarks, and so on. In addition, the natural attribute information may further include a head avatar and speech self-introduction.

Besides by exchanging the entity cards, card exchange may also be achieved by transmitting and exchanging various informational e-cards. For example, the content on the entity card may be inputted or copied or a photo of which may be taken, and then be transmitted to others via various manners, such as an Instant Messaging (IM) tool, a message, a multimedia message (MMS) or a data instruction. In addition, a user may fill in his/her card information, send the card information via a Bluetooth function, and then wait to receive the card information of the opposite side, and optionally store the card information of the opposite side to the local mobile phone address book.

However, the Bluetooth-mate-based e-card transmission scheme can't satisfy the requirements for exchanging cards among multiple persons at the same time, and can only achieve the one-to-one exchange, thus the card transmission efficiency is not high.

Besides, in the existing transmission schemes of various types of e-cards, the user information security is not fully taken into account, and key information of user may be easily leaked, which brings about the hidden trouble of information security.

### SUMMARY

In view of above, embodiments of the present disclosure provide a method and device for transmitting an e-card, which can improve the e-card transmission efficiency.

The method for transmitting an e-card provided by embodiments of the present disclosure includes:

determining, by an e-card sender, geographical position information of the e-card sender, and uploading an e-card of the e-card sender and the geographical position information of the e-card sender to a card server;

receiving, by the e-card sender, a list of identifiers of adjacent users determined by the card server according to the geographical position information of the e-card sender;

determining, by the e-card sender, an identifier from the list of identifiers of adjacent users, and sending determined identifier to the card server, so that the card server may send the e-card of the e-card sender to an e-card receiver corresponding to the identifier.

A device for transmitting an e-card provided by embodiments of the present disclosure includes: a memory and a processor in communication with the memory;

the memory stores a group of machine-readable instructions which may be executed by the processor to:

determine geographical position information of an e-card sender;

upload an e-card of the e-card sender and the geographical position information of the e-card sender to a card server;

receive a list of identifiers of adjacent users determined by the card server according to the geographical position information of the e-card sender;

determine an identifier from the list of identifiers of adjacent users, and

send determined identifier to the card server, so that the card server may send the e-card of the e-card sender to an e-card receiver corresponding to the identifier.

Another device for transmitting an e-card provided by embodiments of the present disclosure includes: a memory and a processor in communication with the memory;

the memory stores a group of machine-readable instructions which may be executed by the processor to:

receive an e-card of an e-card sender and geographical position information of the e-card sender uploaded by the e-card sender;

determine a list of identifiers of adjacent users according to the geographical position information of the e-card sender, and send the list of identifiers of adjacent users to the e-card sender;

receive an identifier determined by the e-card sender from the list of identifiers of adjacent users, and send the e-card of the e-card sender to the e-card receiver corresponding to the identifier.

From the above technical solutions it can be seen that in the present disclosure, geographical position information of an e-card sender is determined, and an e-card of the e-card sender and determined geographical position information are uploaded to a card server; the card server determines a list of identifies of adjacent users according to the geographical position information of the e-card sender, and sends the list of identifies of adjacent users to the e-card sender; the e-card sender determines an identifier of an e-card receiver from the list of identifies of adjacent users, and sends the determined identifier of the e-card receiver to the card server; the card server sends the e-card of the e-card sender to an e-card receiver corresponding to the identifier of the e-card receiver. That is to say, the card exchange among multiple persons may be supported in the technical solutions of the present disclosure, thus the card transmission efficiency is increased.

In addition, the present disclosure further prompt the e-card sender whether the user determines to use the card transmission function, and the e-card sender may actively send the e-card to the receiver only according to identifier information (such as a name, thus the telephone of the user cannot be leaked) of the adjacent user, thus the card transmission security may be increased, and the user privacy may be protected.

Furthermore, technical solutions of the present disclosure may be applied to various terminals, and may be used across platforms or across terminals, thus the technical solutions of the present disclosure have a wide application.

### BRIEF DESCRIPTION OF DRAWINGS

FIG. 1 is a flowchart illustrating a method for transmitting an e-card according to an embodiment of the present disclosure;

FIG. 2 is a schematic diagram illustrating a first transmission interface of an e-card according to an example of the present disclosure;

FIG. 3 is a schematic diagram illustrating a second transmission interface of the e-card according to the example of the present disclosure;

FIG. 4 is a schematic diagram illustrating a third transmission interface of the e-card according to the example of the present disclosure;

FIG. 5 is a schematic diagram illustrating a fourth transmission interface of the e-card according to the example of the present disclosure;

FIG. 6 is a flowchart illustrating a method for transmitting an e-card according to an example of the present disclosure;

FIG. 7 is a schematic diagram illustrating a system for transmitting an e-card according to an embodiment of the present disclosure;

FIG. 8 is a schematic diagram illustrating a device for transmitting an e-card according to an embodiment of the present disclosure;

FIG. 9 is a schematic diagram illustrating another device for transmitting an e-card according to an embodiment of the present disclosure;

FIG. 10 is a schematic diagram illustrating a device for transmitting an e-card according to another embodiment of the present disclosure;

FIG. 11 is a schematic diagram illustrating another device for transmitting an e-card according to another embodiment of the present disclosure.

### DETAILED DESCRIPTION

In order to make objectives, technical solutions and advantages of the present disclosure clearer, the present disclosure will be described in detail hereinafter with reference to accompanying drawings.

In embodiments of the present disclosure, based on wireless network, short-range multi-person secure e-card transmission is achieved via various terminals. The embodiments of the present disclosure are committed to facilitating multiple users to exchange their cards, and guaranteeing the material security of the users.

Preferably, it is necessary for a user to determine whether to use the card exchange function in advance, so that the card transmission security may be increased. Furthermore, after finding multiple adjacent users using the card transmission function via the wireless network, the user may, according to identifier information (such as a name, thus the telephone of the user cannot be leaked) of an adjacent user, actively send the e-card of the user to the adjacent user, preferably, without a determination made by the opposite side (namely the adjacent user). Similarly, the opposite side may send an e-card of the opposite side to a receiver by adopting the same method.

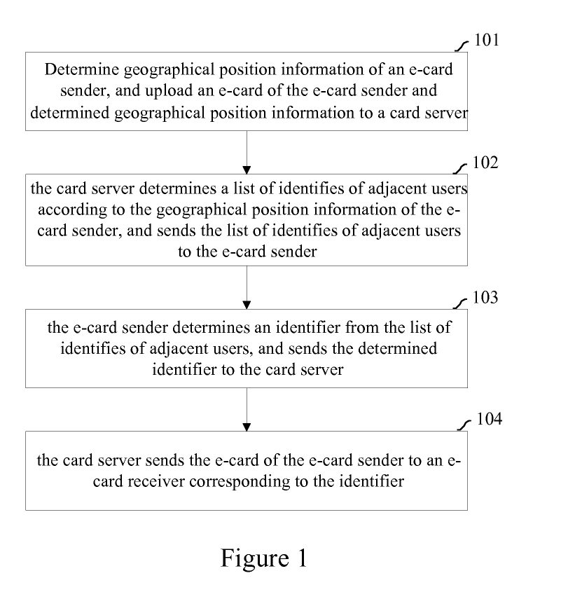

FIG. 1 is a flowchart illustrating a method for transmitting an e-card according to an embodiment of the present disclosure. As shown in FIG. 1, the method includes the following processes.

In block 101, geographical position information of an e-card sender is determined, and an e-card of the e-card sender and determined geographical position information are uploaded to a card server.

Here, the e-card sender includes but only is limited to: a feature phone, a smartphone, a handheld computer, a personal computer (PC), a tablet PC, a personal digital assistant (PDA), or the like.

Preferably, before the e-card of the e-card sender and the determined geographical position information are uploaded to the card server, a user of the e-card sender is prompted to send an upload determination instruction, so as to increase the information security. After the upload determination instruction sent by the user is received, the e-card of the e-card sender and the determined geographical position information are uploaded to the card server.

The e-card sender and the card server may establish a communications connection via a variety of wireless communications networks.

According to a relationship between the information transmission direction and time, the communications mode between the e-card sender and the card server may be simplex communications mode, half-duplex communications mode, full-duplex communications mode, or the like.

In embodiments of the present disclosure, the e-card sender and the card server may predetermine a specific communications protocol, and predefine, in the communications protocol, a format used by a data unit, information and meaning thereof which an information unit should include, a connection type, the sequence for sending and receiving information, so as to guarantee that data in the network may be successfully transmitted to a determined place.

For example, the communications protocols may be adopted in embodiments of the present disclosure include but are not limited to: Transmission Control Protocol/Internet Protocol (TCP/IP), Hypertext Transfer Protocol (HTTP), Simple Mail Transfer Protocol (SMTP), Post Office Protocol-Version 3 (POP3), or the like.

In embodiments of the present disclosure, the e-card sender may perform information interaction with the card server via a variety of communications standards, such as Global System for Mobile Communications (GSM), Wideband Code Division Multiple Access (WCDMA), Code Division Multiple Access 2000 (CDMA-2000), Time Division-Synchronous Code Division Multiple Access (TD-SCDMA), or the like.

The information interaction format adopted by the e-card sender and the card server may be but not limited to: Short Messaging Service (SMS), E-mail, Instant Messaging (IM) message, Multimedia Message (MMS), voice message, or the like.

Although some specific information interaction formats between the e-card sender and the card server are listed above, those skilled in the art may know that, the formats listed above are only some examples, and will not limit the embodiments of the present disclosure.

In an example, receiving the upload determination instruction sent by the user may include the following: receiving a shake event, of the e-card sender, which is detected by a gravity accelerometer; receiving a screen-touch event, of the e-card sender, which is detected by a touch sensor; or receiving a key-stroke event, of the e-card sender, which is detected by a keyboard sensor. For example, some terminals may detect accelerations of three directions via a built-in three-axis (x, y, z) accelerometer, so as to determine a holding action of the terminal user.

Before the geographical position information of the e-card sender is determined, the method may further include: the user is informed to send a positioning determination instruction, and after the positioning determination instruction sent by the user is received, a positioning request is sent to a positioning server. The positioning server returns the geographical position information of the e-card sender to the e-card sender.

Similarly, receiving the positioning determination instruction sent by the user may include the following: receiving a shake event, of the e-card sender, which is detected by a gravity accelerometer; receiving a screen-touch event, of the e-card sender, which is detected by a touch sensor; or receiving a key-stroke event, of the e-card sender, which is detected by a keyboard sensor. For example, some terminals may detect accelerations of three directions via a built-in three-axis (x, y, z) accelerometer, so as to determine a holding action of the terminal user.

Specifically, the geographical position information of the e-card sender may be determined through many methods. For example, the geographical position information of the e-card sender may be determined based on Global Positioning System (GPS) positioning, or based on the base station positioning in a mobile operator network.

The GPS positioning method refers to that a GPS positioning module in the terminal is used to send the position signal of the terminal to a positioning background to achieve the mobile phone positioning. The base station positioning method refers to that the terminal position is determined according to a distance, between the base station and the terminal, measured by the base station.

When using the base station positioning in the mobile operator network, it is not necessary for the terminal to have the GPS positioning function, but the positioning accuracy depends heavily on the distribution of the base stations and the size of the coverage of the base stations, sometimes the error may exceed one kilometer. However, the positioning accuracy through the GPS positioning is higher.

In an example, the mobile operator network may adopt GSM, WCDMA, CDMA-2000, TD-SCDMA, or the like.

For example, after enabling the card exchange function, the e-card sender may instruct the user of the e-card sender to determine the current position. After the user of the e-card sender achieves the positioning via a positioning method, such as GPS positioning or wireless communications network positioning technology, the e-card sender may send prompt information for instructing the user to shake the terminal, so as to report the e-card and the determined geographical position information to the card server.

Although the specific implementation methods of the e-card sender and the specific methods for receiving the upload determination instruction are listed above, those skilled in the art may know that, the methods listed above are only some examples, and will not limit the embodiments of the present disclosure.

In block 102, the card server determines a list of identifies of adjacent users according to the geographical position information of the e-card sender, and sends the list of identifies of adjacent users to the e-card sender.

Here, the card server may, according to the geographical position information of the e-card sender, search a user geographical position information database to determine an identifier of an adjacent user the geographical distance from which to the e-card sender is less than a predetermined distance value in a determined time period. The user geographical position information database stores geographical position information reported by each user in the determined time period, the card server may determine identifiers of all adjacent users the geographical distances from which to the e-card sender are less than the predetermined distance value in the determined time period via a specific distance algorithm, gathers the identifiers of all adjacent users into a list of identifies of adjacent users, and sends the list to the e-card sender.

In block 103, the e-card sender determines an identifier of an e-card receiver from the list of identifies of adjacent users, and sends the determined identifier of the e-card receiver to the card server.

Here, when determining the identifier of the e-card receiver, the e-card sender may determine a name of an adjacent user to which the e-card sender is interested.

In block 104, the card server sends the e-card of the e-card sender to an e-card receiver corresponding to the identifier of the e-card receiver.

For example, the e-card receiver includes but is not limited to: a feature phone, a smartphone, a handheld computer, a PC, a tablet PC, a PDA, or the like.

In an example, after receiving the e-card, the e-card receiver may make a determination as to whether to store the e-card. When to store the e-card, the e-card receiver may store the e-card to an address book of the e-card receiver; otherwise, the e-card receiver may discard the e-card.

For user information security, a protection measure, such as screen saver settings, and single information association, e.g. fingerprint association and mobile phone International Mobile Equipment Identity (IEMI) association, may be performed on the e-card sender, thus the information security may be ensured.

In an example, before the card server sends the e-card of the e-card sender to the e-card receiver corresponding to the identifier of the e-card receiver, the method may further include the following. The card server verifies whether the identity of the e-card sender is legal, and only when the identity of the e-card sender is legal, the card server sends the e-card to the e-card receiver corresponding to the identifier of the e-card receiver. The method for verifying whether the identity of the e-card sender is legal may include: verifying whether the fingerprint of the user of the e-card sender is consistent with an authorized fingerprint, verifying whether the iris of the user of the e-card sender is consistent with an authorized iris, verifying whether the IEMI of the e-card sender is legal, or verifying whether the password of the screen saver settings inputted by the user of the e-card sender is correct.

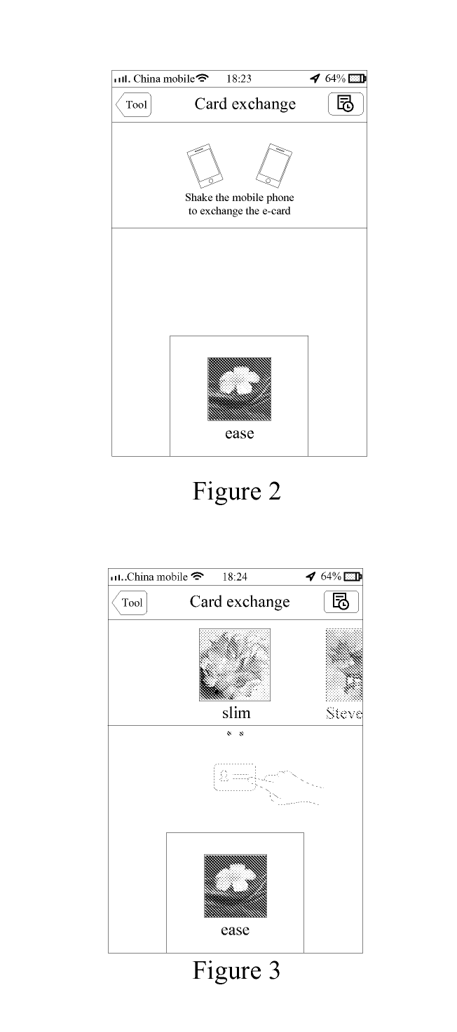

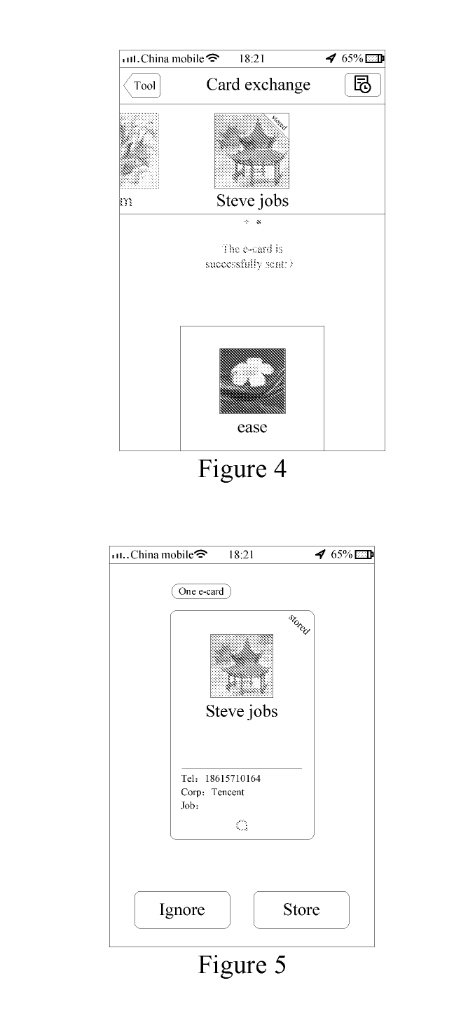

Based on above mentioned description, FIG. 2 is a schematic diagram illustrating a first transmission interface of an e-card according to an example of the present disclosure; FIG. 3 is a schematic diagram illustrating a second transmission interface of the e-card according to the example of the present disclosure; FIG. 4 is a schematic diagram illustrating a third transmission interface of the e-card according to the example of the present disclosure; FIG. 5 is a schematic diagram illustrating a fourth transmission interface of the e-card according to the example of the present disclosure.

As shown in above mentioned FIGS. 2 to 5, an App dedicated to exchange an e-card on the client is started first, and after the App is started and the card exchange function is enabled, the user may be prompted to determine the current position of the e-card sender, and when the positioning of the current position is achieved, a prompt for instructing the user to shake the terminal may be sent to the user, so as to report the current e-card of the user and the current geographical position information of the user to the card server.

After the client of the user reports the geographical position information of the client to the card server, the card server may, according to the geographical position information of the client and report time indicating when the geographical position information of the client is reported, search for geographical position information reported by all other clients within a time period within which the geographical position information of the client is reported, and select other clients, close to the client, of a predetermined number, and generate a list of identifiers of clients.

After receiving the list of identifiers of clients, the client may display the head avatar and name of terminals in the list of identifiers of clients. After the user slides and selects a corresponding target client, the client sends an e-card to the target client. When the user slides and selects the target client, if the head avatar of the opposite side is in the center of the screen, it means that the user of the head avatar is the e-card receiver. After the user selects the target client, the user of e-card sender may slide the e-card of the user to represent that the e-card of the e-card sender may be actively sent to the e-card receiver.

In another example, when the client sends the e-card of the client to a receiver, the client may send an e-card sending request to the card server, the e-card sending request carries identifier information of the receiver and card information of the user of the client. After receiving the e-card sending request, the card server sends the card information of the user of the client to the receiver corresponding to the identifier information of the receiver. After receiving the card information (within a time period, the receiver may receive one or more e-cards), the receiver may display the received card information to the user of the receiver to give the user a prompt for processing.

Preferably, the user may, according to his/her own requirements, ignore a receive e-card or store an e-cards the user want to an address book. The received e-cards may be stored in a historical card receiving database, to facilitate the user performing the subsequent processing.

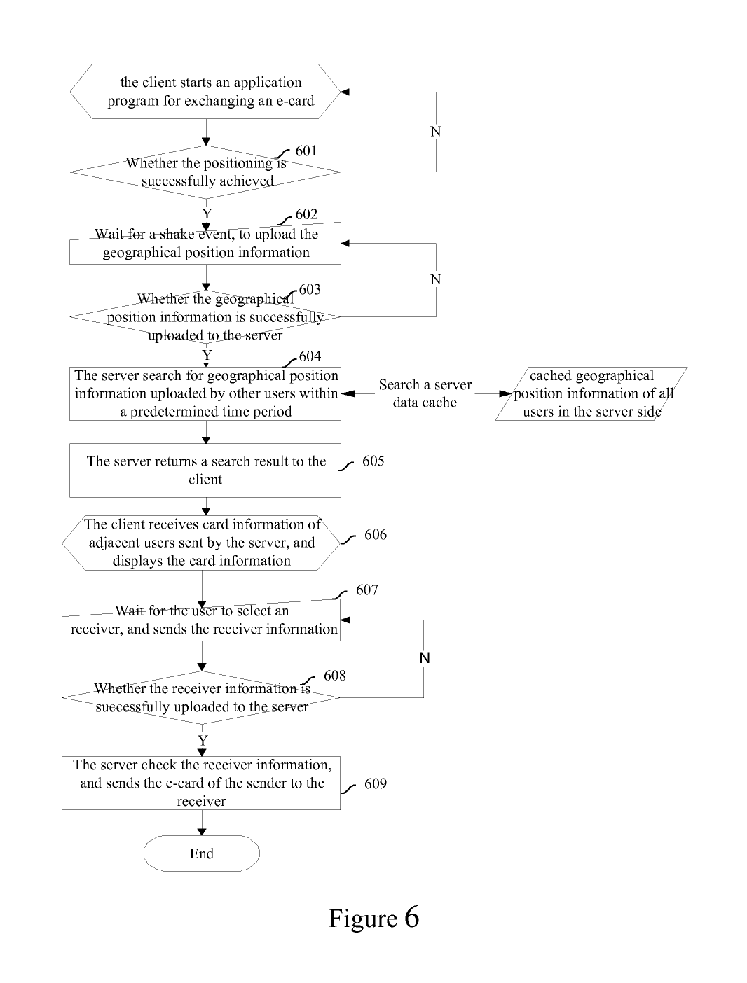

Based on above mentioned description, FIG. 6 shows a method for transmitting an e-card according to an example of the present disclosure. As shown in FIG. 6, the method may include the following processes.

At first, the client starts an application program for exchanging an e-card.

In block 601, the client is queried whether to perform the geographical position positioning, when the client determines to perform the geographical position positioning, the client is further queried whether the geographical position positioning is successful, and when the geographical position positioning is successful, block 602 is performed; otherwise, the client restarts the application program for exchanging an e-card.

In block 602, the client detects whether a shake event occurs (namely whether the user shakes the client device), so as to determine whether to upload the geographical position information of the client and the e-card of the user of the client to the server, to search for adjacent users. When detecting a shake event, the client uploads the geographical position information obtained in block 601 to the server.

In block 603, a determination is made as to whether the client uploads the geographical position information to the server, when the client uploads the geographical position information to the server, block 604 is performed; otherwise, block 602 is performed.

In block 604, after receiving the geographical position information uploaded by the client, the server searches for geographical position information uploaded by other users within a predetermined time period. Here, the users adjacent to the client within the predetermined time period may be determined according to cached geographical position information of users of all clients.

In block 605, the server determines adjacent users of predetermined number according to a corresponding algorithm, and gathers the adjacent users to a list of adjacent users, and returns the list of adjacent users to the client. The list of adjacent users may include information of the adjacent users, such as an identifier, a name, gender and a head avatar. Preferably, the list of adjacent users does not include card information of the adjacent users.

In block 606, the client receives the list of adjacent users sent by the server, and displays the list of adjacent users.

In block 607, the client selects an adjacent user (for example, selects the name, identifier or the head avatar of the adjacent user), to which the client is interested, from the list of adjacent users, and sends identifier information indicating the identity of the adjacent user to the server.

In block 608, a determination is made as to whether the client successfully uploads the identifier information of the adjacent user to the server, when the client successfully uploads the identifier information of the adjacent user to the server, block 609 is performed; otherwise, block 607 is performed.

In block 609, after receiving the identifier information of the adjacent user determined by the client, the server determines an adjacent user corresponding to the identifier information of the adjacent user, and sends the card information of the client to the adjacent user.

Based on above mentioned method, the embodiments of the present disclosure also provide a system for transmitting an e-card.

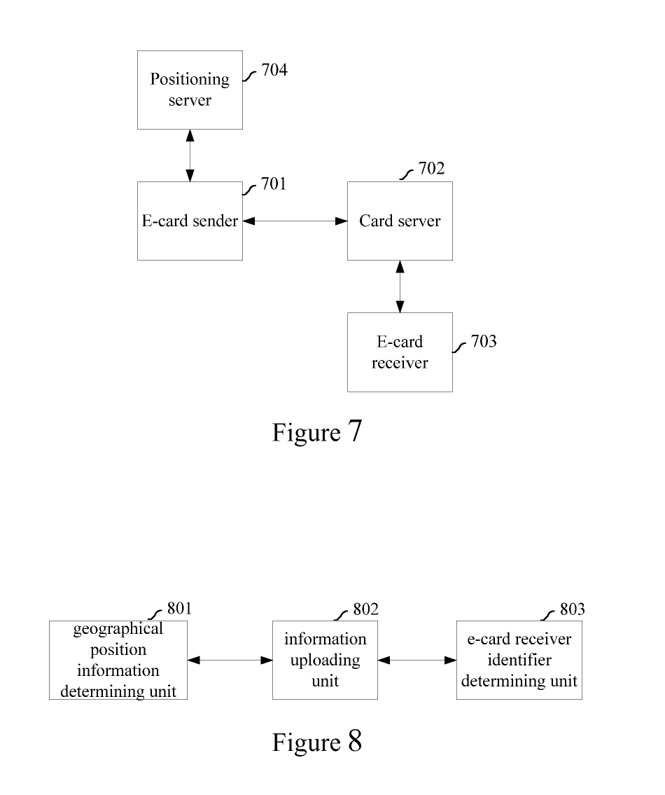

FIG. 7 is a schematic diagram illustrating a system for transmitting an e-card according to an embodiment of the present disclosure. As shown in FIG. 7, the system includes an e-card sender 701 and a card server 702.

The e-card sender 701 is configured to determine geographical position information of the e-card sender 701, and upload an e-card of the e-card sender 701 and the determined geographical position information to the card server 702; determine an identifier of an e-card receiver from a list of identifiers of adjacent users sent by the card server, and send the determined identifier of the e-card receiver to the card server 702.

The card server 702 is configured to determine the list of identifiers of adjacent users according to the geographical position information of the e-card sender 701, and send the list of identifiers of adjacent users to the e-card sender 701, and send the e-card of the e-card sender 701 to the e-card receiver 703 corresponding to the identifier of the e-card receiver.

The e-card sender includes but only is limited to: a feature phone, a smartphone, a handheld computer, a PC, a tablet PC, a PDA, or the like.

Preferably, before uploading the e-card of the e-card sender 701 and the determined geographical position information to the card server 702, a user of the e-card sender 701 may be informed of sending an upload determination instruction, so as to increase the information security. After the upload determination instruction sent by the user is received, the e-card sender 701 uploads the e-card of the e-card sender 701 and the determined geographical position information to the card server 702.

The e-card sender 701 and the card server 702 may establish a communications connection via a variety of wireless communications networks.

According to a relationship between the information transmission direction and time, the communications mode between the e-card sender 701 and the card server 702 may be simplex communications mode, half-duplex communications mode, full-duplex communications mode, or the like.

In embodiments of the present disclosure, the e-card sender 701 and the card server 702 may predetermine a specific communications protocol, and predefine, in the communications protocol, a format used by a data unit, information and meaning thereof which an information unit should include, a connection type, the sequence for sending and receiving information, so as to guarantee that data in the network may be successfully transmitted to a determined place.

For example, the communications protocols may be adopted in embodiments of the present disclosure include but are not limited to: TCP/IP, HTTP, SMTP, POP3, or the like.

In embodiments of the present disclosure, the e-card sender 701 may perform information interaction with the card server 702 via a variety of communications standards, such as GSM, WCDMA, CDMA-2000, TD-SCDMA, or the like.

The information interaction format adopted by the e-card sender 701 and the card server 702 may be but not limited to: SMS, E-mail, IM message, MMS, voice message, or the like.

In an example, the e-card sender 701 may receive the upload determination instruction by receiving a shake event, of the e-card sender, which is detected by a gravity accelerometer; by receiving a screen-touch event, of the e-card sender, which is detected by a touch sensor; or by receiving a key-stroke event, of the e-card sender, which is detected by a keyboard sensor.

Preferably, the card server 702 may, according to the geographical position information of the e-card sender 701, search a user geographical position information database to determine identifiers of adjacent users the geographical distance from each of which to the e-card sender 701 is less than a predetermined distance value in a predetermined time period.

In an example, after receiving the e-card, the e-card receiver 703 may make a determination as to whether to store the e-card. When to store the e-card, the e-card receiver 703 may store the e-card to an address book of the e-card receiver 703; otherwise, the e-card receiver 703 may discard the e-card.

In an example, the system may further include a positioning server 704.

Correspondingly, the e-card sender 701 may further inform the user of sending a positioning determination instruction before determining the geographical position information of the e-card sender 701, and when receiving the positioning determination instruction sent by the user, send a positioning request to the positioning server 704. The positioning server 704 is configured to return the geographical position information of the e-card sender to the e-card sender 701.

In an example, the e-card sender 701 may receive the positioning determination instruction by receiving a shake event, of the e-card sender, which is detected by a gravity accelerometer; by receiving a screen-touch event, of the e-card sender, which is detected by a touch sensor; or by receiving a key-stroke event, of the e-card sender, which is detected by a keyboard sensor.

In an example, before sending the e-card of the e-card sender to the e-card receiver corresponding to the identifier of the e-card receiver, the card server 702 may verify whether the identity of the e-card sender is legal, and only when the identity of the e-card sender is legal, the card server sends the e-card to the e-card receiver corresponding to the identifier of the e-card receiver. The method for verifying, by the card server, whether the identity of the e-card sender is legal may include: verifying whether the fingerprint of the user of the e-card sender is consistent with an authorized fingerprint, verifying whether the iris of the user of the e-card sender is consistent with an authorized iris, verifying whether the IEMI of the e-card sender is legal, or verifying whether the password of the screen saver settings inputted by the user of the e-card sender is correct.

Embodiments of the present disclosure also provide a device for transmitting an e-card.

FIG. 8 is a schematic diagram illustrating a device for transmitting an e-card according to an embodiment of the present disclosure. As shown in FIG. 8, the device for transmitting an e-card includes a geographical position information determining unit 801, an information uploading unit 802 and an e-card receiver identifier determining unit 803.

The geographical position information determining unit 801 is configured to determine geographical position information of the device for transmitting an e-card.

The information uploading unit 802 is configured to upload an e-card of the device for transmitting an e-card and the geographical position information determined by the geographical position information determining unit 801 to a card server.

The e-card receiver identifier determining unit 803 is configured to receive a list of identifiers of adjacent users determined by the card server according to the geographical position information of the device for transmitting an e-card, determine an identifier of an e-card receiver from the list of identifiers of adjacent users, and send the determined identifier of the e-card receiver to the card server, so that the card server may send the e-card of the device for transmitting an e-card to an e-card server corresponding to the identifier of the e-card receiver.

Specifically, before the information uploading unit 802 uploads the e-card of the device for transmitting an e-card and the determined geographical position information to the card server, the user may be informed of sending an upload determination instruction. After receiving the upload determination instruction sent by the user, the information uploading unit 802 uploads the e-card of the device for transmitting an e-card and the determined geographical position information to the card server.

Furthermore, before the geographical position information determining unit 801 determines the geographical position information of the device for transmitting an e-card, the user may be informed of sending a positioning determination instruction, and when receiving the positioning determination instruction sent by the user, the geographical position information determining unit 801 sends a positioning request to a positioning server, and receives geographical position information, of the device for transmitting an e-card, returned by the positioning server.

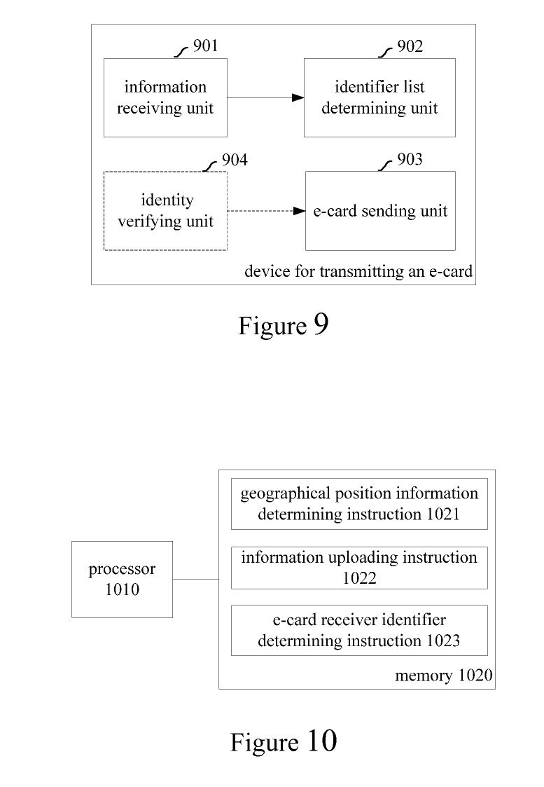

FIG. 9 is a schematic diagram illustrating another device for transmitting an e-card according to an embodiment of the present disclosure. As shown in FIG. 9, the device includes an information receiving unit 901, an identifier list determining unit 902 and an e-card sending unit 903.

The information receiving unit 901 is configured to receive an e-card and geographical position information of an e-card sender uploaded by the e-card sender.

The identifier list determining unit 902 is configured to determine a list of identifiers of adjacent users according to the geographical position information of the e-card sender, and send the list of identifiers of adjacent users to the e-card sender.

The e-card sending unit 903 is configured to receive an identifier of an e-card receiver determined by the e-card sender from the list of identifiers of adjacent users, and send the e-card of the e-card sender to the e-card receiver corresponding to the identifier of the e-card receiver.

The identifier list determining unit 902 may, according to the geographical position information of the e-card sender, search a user geographical position information database to determine identifiers of adjacent users the geographical distance from each of which to the e-card sender is less than a predetermined distance value in a predetermined time period.

As shown in sashed line part of FIG. 9, the device for transmitting an e-card may further include an identity verifying unit 904, which is configured to verify whether the identity of e-card sender is legal before the e-card sending unit 903 sends the e-card, and when the identity of e-card sender is legal, notify the e-card sending unit 903 of sending the e-card to the e-card receiver corresponding to the identifier. The method for verifying, by the identity verifying unit 904, whether the identity of the e-card sender is legal may include: verifying whether the fingerprint of the user of the e-card sender is consistent with an authorized fingerprint, verifying whether the iris of the user of the e-card sender is consistent with an authorized iris, verifying whether the IEMI of the e-card sender is legal, or verifying whether the password of the screen saver settings inputted by the user of the e-card sender is correct.

The device for transmitting an e-card shown in FIG. 8 may work as the e-card sender, and the device for transmitting an e-card shown in FIG. 9 may work as the card server.

The device for transmitting an e-card may be integrated to a hardware entity of a communications network. For example, the device for transmitting an e-card may be integrated to a feature phone, a smartphone, a handheld computer, a PC, a tablet PC, a PDA, or the like.

The above examples may be implemented by hardware, software, firmware, or a combination thereof. For example the various methods, processes and functional modules described herein may be implemented by a processor (the term processor is to be interpreted broadly to include a CPU, processing unit/module, ASIC, logic module, or programmable gate array, etc.). The processes, methods and functional modules may all be performed by a single processor or split between several processors; reference in this disclosure or the claims to a ‘processor’ should thus be interpreted to mean ‘one or more processors’. The processes, methods and functional modules are implemented as machine readable instructions executable by one or more processors, hardware logic circuitry of the one or more processors or a combination thereof. The modules, if mentioned in the aforesaid examples, may be combined into one module or further divided into a plurality of sub-modules. Further, the examples disclosed herein may be implemented in the form of a software product. The computer software product is stored in a non-transitory storage medium and comprises a plurality of instructions for making an electronic device implement the method recited in the examples of the present disclosure. The non-transitory storage medium includes a hard disk, a floppy disk, a magnetic disk, a compact disk (e.g., CD-ROM, CD-R, CD-RW, DVD-ROM, DVD-RAM, DVD-RW and DVD+RW), a tape, a Flash card, ROM, and so on. Optionally, it is possible to download the program codes from a server computer via a communication network.

For example, FIG. 10 is a schematic diagram illustrating a device for transmitting an e-card according to another embodiment of the present disclosure. As shown in FIG. 10, the device may include a memory 1020 and a processor 1010 in communication with the memory 1020.

The memory 1020 may store a group of machine-readable instructions which may be executed by the processor 1010. The machine-readable instructions may include a geographical position information determining instruction 1021, an information uploading instruction 1022 and an e-card receiver identifier determining instruction 1023 which may be respectively executed by the processor 820 to respectively implement the operations of the geographical position information determining unit 801, the information uploading unit 802 and the e-card receiver identifier determining unit 803 mentioned above.

Specifically, the geographical position information determining instruction 1021 may indicate: determining geographical position information of the device.

The information uploading instruction 1022 may indicate: uploading an e-card and the geographical position information of the device to a card server.

The e-card receiver identifier determining instruction 1023 may indicate: receiving a list of identifiers of adjacent users determined by the card server according to the geographical position information of the device, determining an identifier of an e-card receiver from the list of identifiers of adjacent users, and sending the determined identifier of the e-card receiver to the card server, so that the card server may send the e-card of the device to an e-card server corresponding to the identifier of the e-card receiver.

Specifically, before uploading the e-card of the device and the determined geographical position information to the card server, the user may be informed of sending an upload determination instruction. After receiving the upload determination instruction sent by the user, the information uploading instruction 1022 indicates uploading the e-card of the device and the determined geographical position information to the card server.

Furthermore, before determining the geographical position information of the device, the user may be informed of sending a positioning determination instruction, and when receiving the positioning determination instruction sent by the user, the geographical position information determining instruction 1021 indicates sending a positioning request to a positioning server, and receives geographical position information of the device returned by the positioning server.

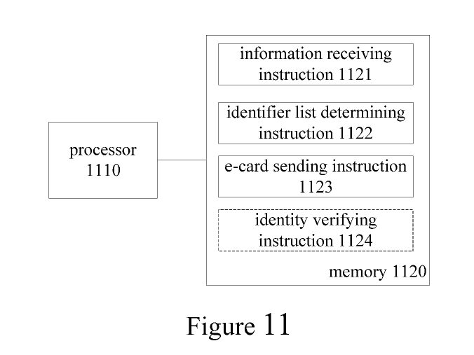

FIG. 11 is a schematic diagram illustrating another device for transmitting an e-card according to another embodiment of the present disclosure. As shown in FIG. 11, the device may include a memory 1120 and a processor 1110 in communication with the memory 1120.

The memory 1120 may store a group of machine-readable instructions which may be executed by the processor 1110. The machine-readable instructions may include an information receiving instruction 1121, an identifier list determining instruction 1122 and an e-card sending instruction 1123, which may be respectively executed by the processor 820 to respectively implement the operations of the information receiving unit 901, the identifier list determining unit 902 and the e-card sending unit 903 mentioned above.

Specifically, the information receiving instruction 1121 may indicate: receiving an e-card and geographical position information of an e-card sender uploaded by the e-card sender.

The identifier list determining instruction 1122 may indicate: determining a list of identifiers of adjacent users according to the geographical position information of the e-card sender, and sending the list of identifiers of adjacent users to the e-card sender.

The e-card sending instruction 1123 may indicate: receiving an identifier of an e-card receiver determined by the e-card sender from the list of identifiers of adjacent users, and sending the e-card of the e-card sender to the e-card receiver corresponding to the identifier of the e-card receiver.

Specifically, the identifier list determining instruction 1122 may, according to the geographical position information of the e-card sender, search a user geographical position information database to determine identifiers of adjacent users the geographical distance from each of which to the e-card sender is less than a predetermined distance value in a predetermined time period.

Furthermore, as shown in sashed line part of FIG. 11, the memory 1120 may further include an identity verifying instruction 1124, which is configured to verify whether the identity of e-card sender is legal before the e-card sending instruction 1123 indicates sending the e-card, and when the identity of e-card sender is legal, notify the e-card sending instruction 1123 of sending the e-card to the e-card receiver corresponding to the identifier. The method for verifying whether the identity of the e-card sender is legal may include: verifying whether the fingerprint of the user of the e-card sender is consistent with an authorized fingerprint, verifying whether the iris of the user of the e-card sender is consistent with an authorized iris, verifying whether the IEMI of the e-card sender is legal, or verifying whether the password of the screen saver settings inputted by the user of the e-card sender is correct.

The device for transmitting an e-card shown in FIG. 10 may work as the e-card sender, and the device for transmitting an e-card shown in FIG. 11 may work as the card server.

In conclusion, embodiments of the present disclosure disclose a method, system and device for transmitting an e-card. The method includes: geographical position information of an e-card sender is determined, and an e-card of the e-card sender and determined geographical position information are uploaded to a card server; the card server determines a list of identifies of adjacent users according to the geographical position information of the e-card sender, and sends the list of identifies of adjacent users to the e-card sender; the e-card sender determines an identifier of an e-card receiver from the list of identifies of adjacent users, and sends the determined identifier of the e-card receiver to the card server; the card server sends the e-card of the e-card sender to an e-card receiver corresponding to the identifier of the e-card receiver.

Scheme of the present disclosure supports card exchange among multiple persons, thus the card transmission efficiency is increased. Scheme of the present disclosure may be applied to various terminals, and may be used across platforms or across terminals, thus the scheme of the present disclosure has a wide application.

In addition, embodiments of the present disclosure further prompt the e-card sender whether the user determines to use the card transmission function, and the e-card sender may actively send the e-card to the receiver only according to identifier information (such as a name, thus the telephone of the user cannot be leaked) of the adjacent user, thus the card transmission security may be increased, and the user privacy may be protected.

The foregoing description is only preferred embodiments of the present disclosure and is not used for limiting the protection scope thereof. Any modification, equivalent substitution, or improvement made without departing from the spirit and principle of the present disclosure should be covered by the protection scope of the present disclosure.

1. A method for transmitting an e-card, comprising:
determining, by an e-card sender, geographical position information of the e-card sender;
uploading an e-card of the e-card sender and the geographical position information of the e-card sender to a card server;
receiving, by the e-card sender, a list of identifiers of adjacent users determined by the card server according to the geographical position information of the e-card sender;
determining, by the e-card sender, an identifier from the list of identifiers of adjacent users; and
sending determined identifier to the card server, so that the card server may send the e-card of the e-card sender to an e-card receiver corresponding to the identifier.

2. The method according to claim 1, before uploading the e-card of the e-card sender and the geographical position information of the e-card sender to the card server, the method further comprises: prompting the user to send an upload determination instruction;
after receiving the upload determination instruction, uploading the e-card of the e-card sender and the geographical position information of the e-card sender to the card server.

3. The method according to claim 2, wherein receiving the upload determination instruction comprises:
receiving a shake event, of the e-card sender, which is detected by a gravity accelerometer.

4. The method according to claim 2, wherein receiving the upload determination instruction comprises:
receiving a screen-touch event, of the e-card sender, which is detected by a touch sensor.

5. The method according to claim 2, wherein receiving the upload determination instruction comprises:
receiving a key-stroke event, of the e-card sender, which is detected by a keyboard sensor.

6. The method according to claim 1, before determining geographical position information of the e-card sender, the method further comprises:
prompting the user to send an positioning determination instruction;
when receiving the positioning determination instruction, sending a positioning request to a positioning server; and
receiving the geographical position information, of the e-card sender, returned by the positioning server.

7. The method according to claim 6, wherein receiving the positioning determination instruction comprises:
receiving a shake event, of the e-card sender, which is detected by a gravity accelerometer.

8. The method according to claim 6, wherein receiving the positioning determination instruction comprises:
receiving a screen-touch event, of the e-card sender, which is detected by a touch sensor.

9. The method according to claim 6, wherein receiving the positioning determination instruction comprises:
receiving a key-stroke event, of the e-card sender, which is detected by a keyboard sensor.

10. The method according to claim 1, further comprising:
within a determined time period, according to the geographical position information of the e-card sender, searching, by the card server, a user geographical position information database to determine an identifier of an adjacent user the geographical distance from which to the e-card sender is less than a predetermined distance value;
gathering determined identifiers of adjacent users into a list of identifies of adjacent users; and
sending the list of identifies of adjacent users to the e-card sender.

11. The method according to claim 1, further comprising:
verifying, by the card server, whether the fingerprint of the user of the e-card sender is consistent with an authorized fingerprint, and when the fingerprint of the user of the e-card sender is consistent with an authorized fingerprint, sending, by the card server, the e-card of the e-card sender to the e-card receiver corresponding to the identifier.

12. The method according to claim 1, further comprising:
verifying, by the card server, whether the iris of the user of the e-card sender is consistent with an authorized iris, and when the iris of the user of the e-card sender is consistent with an authorized iris, sending, by the card server, the e-card of the e-card sender to the e-card receiver corresponding to the identifier.

13. The method according to claim 1, further comprising:
verifying, by the card server, whether the IEMI of the e-card sender is legal, and when the IEMI of the e-card sender is legal, sending, by the card server, the e-card of the e-card sender to the e-card receiver corresponding to the identifier.

14. The method according to claim 1, further comprising:
verifying, by the card server, whether the password of the screen saver settings inputted by the user of the e-card sender is correct, and when the password of the screen saver settings inputted by the user of the e-card sender is correct, sending, by the card server, the e-card of the e-card sender to the e-card receiver corresponding to the identifier.

15. A device for transmitting an e-card, comprising: a memory and a processor in communication with the memory;
the memory stores a group of machine-readable instructions which may be executed by the processor to:
determine geographical position information of an e-card sender;
upload an e-card of the e-card sender and the geographical position information of the e-card sender to a card server;
receive a list of identifiers of adjacent users determined by the card server according to the geographical position information of the e-card sender;
determine an identifier from the list of identifiers of adjacent users, and
send determined identifier to the card server, so that the card server may send the e-card of the e-card sender to an e-card receiver corresponding to the identifier.

16. The device according to claim 15, wherein the memory further stores machine-readable instructions which may be executed by the processor to:
prompt the user to send an upload determination instruction before uploading the e-card of the e-card sender and the geographical position information of the e-card sender to the card server; and
after receiving the upload determination instruction, upload the e-card of the e-card sender and the geographical position information of the e-card sender to the card server.

17. The device according to claim 16, wherein the memory stores machine-readable instructions which may be executed by the processor to:
receive a shake event representing upload determination instruction, of the e-card sender, which is detected by a gravity accelerometer.

18. The device according to claim 16, wherein the memory stores machine-readable instructions which may be executed by the processor to:
receive a screen-touch event representing upload determination instruction, of the e-card sender, which is detected by a touch sensor.

19. The device according to claim 15, wherein the memory further stores machine-readable instructions which may be executed by the processor to:
prompt the user to send an positioning determination instruction before determining geographical position information of the e-card sender;
when receiving the positioning determination instruction, send a positioning request to a positioning server; and
receive the geographical position information, of the e-card sender, returned by the positioning server.

20. The device according to claim 19, wherein the memory stores machine-readable instructions which may be executed by the processor to:
receive a shake event representing positioning determination instruction, of the e-card sender, which is detected by a gravity accelerometer.

21. The device according to claim 19, wherein the memory stores machine-readable instructions which may be executed by the processor to:
receive a screen-touch event representing positioning determination instruction, of the e-card sender, which is detected by a touch sensor.

22. A device for transmitting an e-card, comprising: a memory and a processor in communication with the memory;
the memory stores a group of machine-readable instructions which may be executed by the processor to:
receive an e-card of an e-card sender and geographical position information of the e-card sender uploaded by the e-card sender;
determine a list of identifiers of adjacent users according to the geographical position information of the e-card sender, and send the list of identifiers of adjacent users to the e-card sender;
receive an identifier determined by the e-card sender from the list of identifiers of adjacent users, and send the e-card of the e-card sender to the e-card receiver corresponding to the identifier.

23. The device according to claim 22, wherein the memory further stores machine-readable instructions which may be executed by the processor to:
within a determined time period, according to the geographical position information of the e-card sender, search a user geographical position information database to determine an identifier of an adjacent user the geographical distance from which to the e-card sender is less than a predetermined distance value;
gather determined identifiers of adjacent users into a list of identifies of adjacent users; and
send the list of identifies of adjacent users to the e-card sender.

24. The device according to claim 22, wherein the memory further stores machine-readable instructions which may be executed by the processor to:
verify whether the identity of the e-card sender is legal before sending the e-card of the e-card sender to the e-card receiver corresponding to the identifier;
when the identity of the e-card sender is legal, send the e-card of the e-card sender to the e-card receiver corresponding to the identifier.
